(19) United States
(12) Patent Application Publication
(10) Pub. No.: US 2019/0036993 A1
(43) Pub. Date: Jan. 31, 2019

(54) METHOD AND A SYSTEM FOR FACILITATING UNILATERAL BROADCAST OF DATA FROM A SERVER TO A LARGE NUMBER OF CLIENTS, WITHIN A WIRELESS LAN ENVIRONMENT

(71) Applicant: Gabriel LAVI, Raanana (IL)

(72) Inventors: Gabriel LAVI, Raanana (IL); Giora JOSUA, Katzir (IL); Tal RAHAMIM, Ashdod (IL)

(21) Appl. No.: 16/025,274

(22) Filed: Jul. 2, 2018

Related U.S. Application Data
(60) Provisional application No. 62/537,625, filed on Jul. 27, 2017.

(51) Int. Cl. H04L 29/06; H04L 12/761; H04L 29/12

(52) U.S. Cl. CPC H04L 65/4076; H04L 45/16; H04W 84/12; H04L 69/164; H04L 61/6022; H04L 61/103

(57) ABSTRACT

The present invention discloses a method for facilitating unilateral broadcast or multicast of data from a server module to a plurality of client modules, within a WLAN environment, said method comprising the steps of:
execution of dedicated server application and client application on said server module and client modules, respectively;
configuring said server module to initiate a WLAN hotspot network;
Setting the IP address of client modules to a predefined common static IP value, common to all client modules within said WLAN environment;
Configuring said client modules to register to said WLAN hotspot network using said common static IP value;
Broadcasting data from server module to registered client modules via UDP broadcast or multicast protocol.

### FIELD OF THE INVENTION

The presented invention generally relates to the field of wireless local area networks (WLANs), and more specifically relates to the broadcast of data within said WLANs.

### DISCUSSION OF RELATED ART

The usage of Smartphones, as a means for setting up Wireless Local Area Network (WLAN) hotspots and connecting a plurality of clients via the said WLAN hotspots to other networks (e.g. the Internet) is ubiquitous. In such configurations, each client is assigned a unique IP number, enabling it to receive unique data from a specific server on the internet, and transmit unique data back.

On certain scenarios, a unilateral one-to-many type of communication between a single server node and a plurality of client nodes on the WLAN is required, in order to share non-unique data among a large number of clients. An example for such a scenario may be a teacher, presenting a lecture comprising of multimedia content and speech, to a group of 100 students.

The standard solution for facilitating unilateral one-to-many communication in WLAN systems involves broadcasting or multicasting the data over UDP. However, the current state of the art imposes a physical restriction on the WLAN router, severely limiting the manageable number of individual clients that possess unique IP numbers.

### SUMMARY OF THE INVENTION

The present invention discloses a method for facilitating unilateral broadcast or multicast of data from a server module to a plurality of client modules, within a wireless LAN environment, each said server and said plurality of clients comprising a non-transitory computer readable storage device and one or more processors operatively coupled to the storage device on which are stored modules of instruction code executable by the one or more processors, whereupon execution of said instruction codes on the server module and said plurality of client modules carries out the steps of:
initiating a WLAN hotspot network by said server module;
setting the IP address of said client modules to a predefined common static IP value;
wherein said static IP value is common to all client modules within said wireless LAN environment;
registering said client module to said WLAN hotspot network using said common static IP value; and
broadcasting or multicasting data from said server module to said registered client modules of said WLAN hotspot network via UDP broadcast or multicast protocol.

The present invention provides a method for facilitating unilateral broadcast or multicast of data from at least one server module to a plurality of client modules, within at least one wireless LAN environment, each said server and said plurality of clients comprising a non-transitory computer readable storage device and one or more processors operatively coupled to the storage device on which are stored modules of instruction code executable by the one or more processors, whereupon execution of said instruction codes on the server module and said plurality of client modules carries out the steps of:
a. initiating a WLAN hotspot network by said server module;
b. setting the IP address of said client modules to a predefined common static IP value;
c. wherein said static IP value is common to all client modules within said wireless LAN environment;
d. registering said client module to said WLAN hotspot network using said common static IP value; and
e. broadcasting or multicasting data from said server module to said registered client modules of said WLAN hotspot network via UDP broadcast or multicast protocol.
f. According to some embodiments of the present invention registering, comprise the following steps:
launching a client application on a first client module by a first client operator;
presenting to a first client operator a list of SSIDs, presenting available WLAN connections initiated by said server modules;
enabling the first client operator to select a specific server's wireless LAN's SSID;
setting by the client application said first client module's IP to a predefined static value, (“common static IP”).
registering by the client module to the selected server's wireless LAN, using the said selected SSID and said common static IP′; and
registering by the server, the said first client, and storing said common static IP value in conjunction with the first client module's MAC address in the ARP table.
a. According to some embodiments of the present nvention the registering, further comprising the steps of
b. launching a client application on a second, successor client module
c. enables a second client operator to select a guide server's wireless LAN's SSID on the second client module;
d. client application sets the said second client module's IP to the same predefined common static IP value (step 1055).
e. registering to the server module's wireless LAN, using the said selected SSID and common static IP (step 1060).
f. Overriding by the server module the first client's MAC address in the ARP table, and replaces it with the MAC address of the said successor second client module.

According to some embodiments of the present inventionhe broadcasting comprising the steps of:

enabling by server application, the server operator to speak into the server module;

receiving by the server application, the server operator's speech input, and packs the said input as data payload within IP packets. (“speech packets”);

assigning a predefined port (speech port) number to the said speech packets, identifying them as carriers of speech related data;

broadcasting the said speech packets over UDP broadcast or multicast protocol, using the said speech port number, wherein. all client modules within the client group receive the server's broadcast speech packets simultaneously

According to some embodiments of the present invention the client device enables the client operators to permit reconstruction and playing of the said speech data on their respective client modules

According to some embodiments of the present invention the playing of said reconstructed speech data on the client module is processed with no buffering and no delay.

According to some embodiments of the present invention the broadcasting comprising the steps of:

enabling by server application, the server operator to select multimedia data files to be sent to the client modules of the client group;

receiving by the server application executes a dedicated server application, the server operator's select multimedia data, and packs the said select multimedia data as data payload within IP packets. (“multimedia packets”); assigning a predefined port (“multimedia port”) number to the said multimedia packets, identifying them as carriers of speech related data;

broadcasting the said multimedia port packets over UDP broadcast or multicast protocol, using the said multimedia port number, wherein. all client modules within the client group receive the server's broadcast multimedia packets simultaneously.

According to some embodiments of the present invention the method further comprising managing routing, by:
a. receiving request from at least one client device to transmit for pre-define time period;
b. assigning by the server application an additional port with a second predefined port number;
c. managing client requests enabling transmission for pre-defined time period for at least one device through the additional port.
d. According to some embodiments of the present invention the method further comprising managing routing, by:
e. receiving request from client device to transmit for pre-define time period;
f. managing client requests enabling transmission for pre-defined time period for at least one device through the port of the master device; (step 5015)
g. According to some embodiments of the present invention only the server device receive the at least one device broadcast and transmit, said multimedia or speech packets over UDP broadcast or multicast protocol, using the said the first port number to client modules of the group.
h. According to some embodiments of the present invention in case the server device is disconnected, one selected client module may take the place of the sever device, by initiating a WLAN hotspot network, wherein the registration procedure is applied the selected client module.
i. According to some embodiments of the present invention the client device is selected based on programed priority rules.
   i. According to some embodiments of the present invention, the server device is not connected to an external network, such as the Internet or cellular network
j. The present invention provides a system for facilitating unilateral broadcast or multicast of data between communication devices within a wireless LAN environment, said system comprised of:
k. a server module applying a dedicated server application for initiating a WLAN hotspot network;
l. plurality of client modules having a dedicated client application;
m. wherein the sever module set the IP address of said client modules to a predefined common static IP value, wherein said static IP value is common to all client modules within said wireless LAN environment;
n. wherein each client module application registering to said WLAN hotspot network using said common static IP value; and
o. wherein the broadcasting or multicasting data from said server module to said registered client modules of said WLAN hotspot network via UDP broadcast or multicast protocol.

According to some embodiments of the present invention registering, comprise the following steps:
launching a client application on a first client module by a first client operator;
presenting to a first client operator a list of SSIDs, presenting available WLAN connections initiated by said server modules;
enabling the first client operator to select a specific server's wireless LAN's SSID;
setting by the client application said first client module's IP to a predefined static value, (“common static IP”).
registering by the client module to the selected server's wireless LAN, using the said selected SSID and said common static IP′; and
registering by the server, the said first client, and storing said common static IP value in conjunction with the first client module's MAC address in the ARP table.
   a. According to some embodiments of the present invention registering, further comprising the steps of :
   b. launching a client application on a second, successor client module
   c. enables a second client operator to select a guide server's wireless LAN's SSID on the second client module;
   d. client application sets the said second client module's IP to the same predefined common static IP value (step 1055).
   e. registering to the server module's wireless LAN, using the said selected SSID and common static IP (step 1060).
   f. Overriding by the server module the first client's MAC address in the ARP table, and replaces it with the MAC address of the said successor second client module.
   g. According to some embodiments of the present invention the broadcasting comprising the steps of:
      enabling by server application, the server operator to speak into the server module;
      receiving by the server application, the server operator's speech input, and packs the said input as data payload within IP packets. (“speech packets”);
      assigning a predefined port (speech port) number to the said speech packets, identifying them as carriers of speech related data;
      broadcasting the said speech packets over UDP broadcast or multicast protocol, using the said speech port number, wherein. all client modules within the client group receive the server's broadcast speech packets simultaneously

According to some embodiments of the present invention the client device enables the client operators to permit reconstruction and playing of the said speech data on their respective client modules

According to some embodiments of the present invention the play of said reconstructed speech data on the client module is processed with no buffering and no delay.

According to some embodiments of the present nvention the broadcasting comprising the steps of:

enabling by server application, the server operator to select multimedia data files to be sent to the client modules of the client group;

receiving by the server application executes a dedicated server application, the server operator's select multimedia data, and packs the said select multimedia data as data payload within IP packets. (“multimedia packets”); assigning a predefined port (“multimedia port”) number to the said multimedia packets, identifying them as carriers of speech related data;

broadcasting the said multimedia port packets over UDP broadcast or multicast protocol, using the said multimedia port number, wherein. all client modules within the client group receive the server's broadcast multimedia packets simultaneously.

According to some embodiments of the present invention the systems further comprising managing routing, by:
receiving request from at least one client device to transmit for pre-define time period;
assigning by the server application an additional port with a second predefined port number;
managing client requests enabling transmission for pre-defined time period for at least one device through the additional port.

According to some embodiments of the present invention the system further comprising managing routing, by:
receiving request from client device to transmit for pre-define time period;
managing client requests enabling transmission for pre-defined time period for at least one device through the port of the master device; (step 5015)

According to some embodiments of the present invention the server device receive the at least one device broadcast and transmit, said multimedia or speech packets over UDP broadcast or multicast protocol, using the said the first port number to client modules of the group.

According to some embodiments of the present invention, in case the server device is disconnected, one selected client module may take the place of the sever device, by initiating a WLAN hotspot network, wherein the registration procedure is applied the selected client module.

### BRIEF DESCRIPTION OF THE DRAWINGS

FIG. 1 displays a block diagram, depicting an environment of a wireless LAN (WLAN) initiated by a single server module, said environment comprising the said single server module and a plurality of client modules, according to some embodiments of the present invention.

FIGS. 2 and 3 jointly display a flow diagram, depicting the process of clients' registration to the WLAN initiated by the server module, according to some embodiments of the present invention.

FIG. 4 displays a block diagram, depicting an environment comprising of two separate WLANs. Each said WLAN is initiated by a different server module, and comprises a separate, mutually exclusive group of client modules, according to some embodiments of the present invention.

FIG. 5 displays a flow diagram depicting the process of speech data stream broadcast by the server module to the client modules of the client group, and playing said speech data thereof, according to some embodiments of the present invention.

FIG. 6 displays a flow diagram depicting the process of multimedia data broadcast by the server module to the client modules of the client group, and display of said data thereof, according to some embodiments of the present invention.

FIG. 7 displays a flow diagram depicting the process of application level data broadcast by the server module to the client modules of the client group, and display of said data thereof, according to some embodiments of the present invention.

FIG. 8 displays a flow diagram depicting the process of managing Multiple bi directional broadcast port, according to some embodiments of the present invention.

### DETAILED DESCRIPTION OF SOME EMBODIMENTS OF THE INVENTION

Before explaining at least one embodiment of the invention in detail, it to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Following is a table of definitions of the terms used throughout this application.

| Term | Definition |
|---|---|
| Server module | A computerized module comprising a non-transitory computer readable |
| | storage device and one or more processors operatively coupled to the |
| | storage device on which are stored modules of instruction code |
| | executable by the one or more processors, wherein execution of the said |
| | instruction code by said one or more processors implements the steps |
| | elaborated below, including: |
| | Initiating a WLAN hotspot access point; |
| | Registering a plurality of client modules to said WLAN; and |
| | Broadcasting unilateral data to said plurality of client modules. |
| | According to a preferred embodiment, the said server module is embodied |
| | as a smartphone, tablet PC or laptop, possessing the capability of |
| | initiating a hotspot wireless LAN network. |
| Client module | A computerized module comprising a non-transitory computer readable |
| | storage device and one or more processors operatively coupled to the |
| | storage device on which are stored modules of instruction code |
| | executable by the one or more processors, wherein execution of the said |
| | instruction code by said one or more processors implements at least part |
| | of the following steps: |
| | Registering to a WLAN initiated by a server module; and |
| | Receiving unilateral broadcast transmissions from the said server |
| | module. |
| | According to a preferred embodiment, the said server module is embodied |
| | as a smartphone, tablet PC or laptop. |
| Client group | A plurality of clients modules, registered to the WLAN initiated by a |
| | single server module. Said client group is configured to possess a single, |
| | common static IP, and simultaneously receive broadcast transmissions |
| | from the said server module. |
| Server operator | A user, possessing a server module, configured to broadcast unilateral |
| | data to a plurality of client modules. |
| Client operator | A user, possessing a client module, configured to receive said broadcast |
| | unilateral from the guide's server module. |

### DESCRIPTION OF THE DRAWINGS

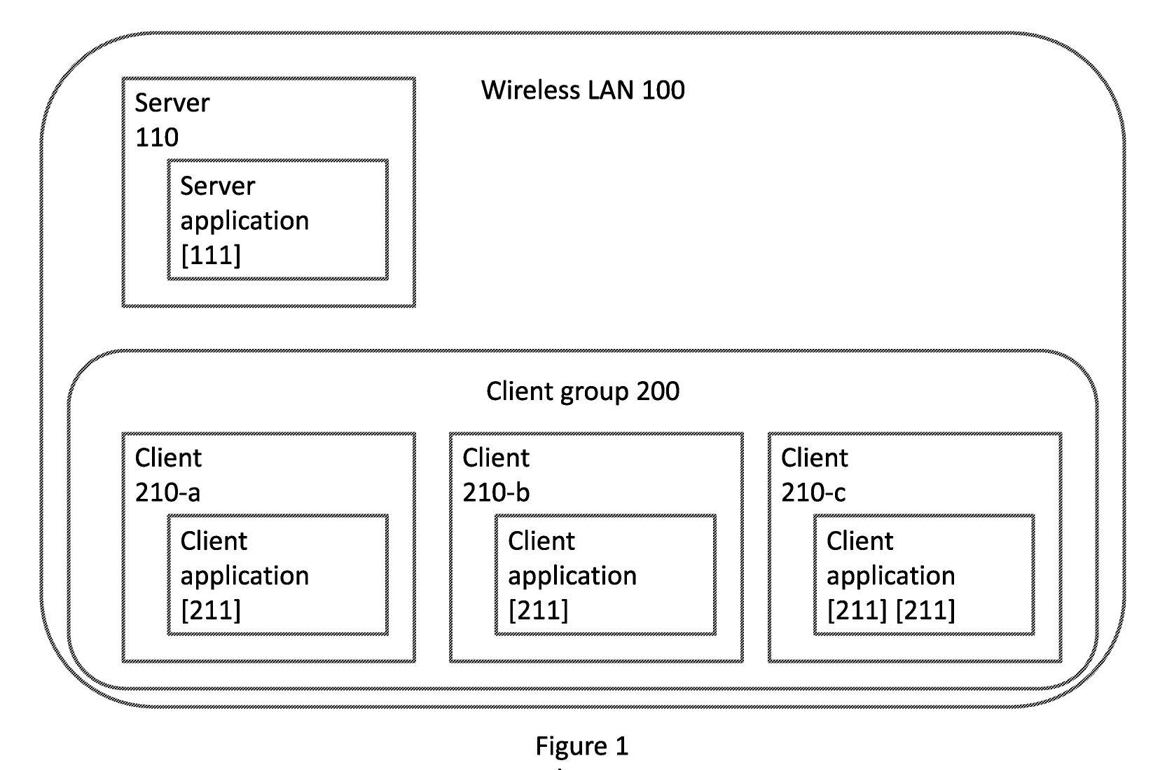

FIG. 1 displays a block diagram, depicting an environment of a wireless LAN (WLAN) initiated by a single server module, said environment comprising the said single server module and a plurality of client modules, according to some embodiments of the present invention.

The present invention facilitates a method for broadcasting various types of data within a WLAN environment, from the said single server module to a practically unlimited group of client modules. This method is implemented by assigning a common static IP address to all the clients of the client group, and simultaneously broadcasting said data from the server module to the plurality of client modules within the client group via a UDP broadcast or multicast protocol.

This broadcasting method can be used for different purposes, such as guided tour, public performances, guidance in disaster areas etc.

The transmission of data by the server, its reception by the clients, and presentation within the clients are managed by dedicated applications, executed on the server and clients respectively.

The server module [110] executes a dedicated server application [111], and each client executes a dedicated client application [211].

According to some embodiments, the said dedicated server application [111] and dedicated client application [211] are implemented as different configurations of the same, identical application. This enables the same modules to serve as either server modules or client modules, according to their configuration.

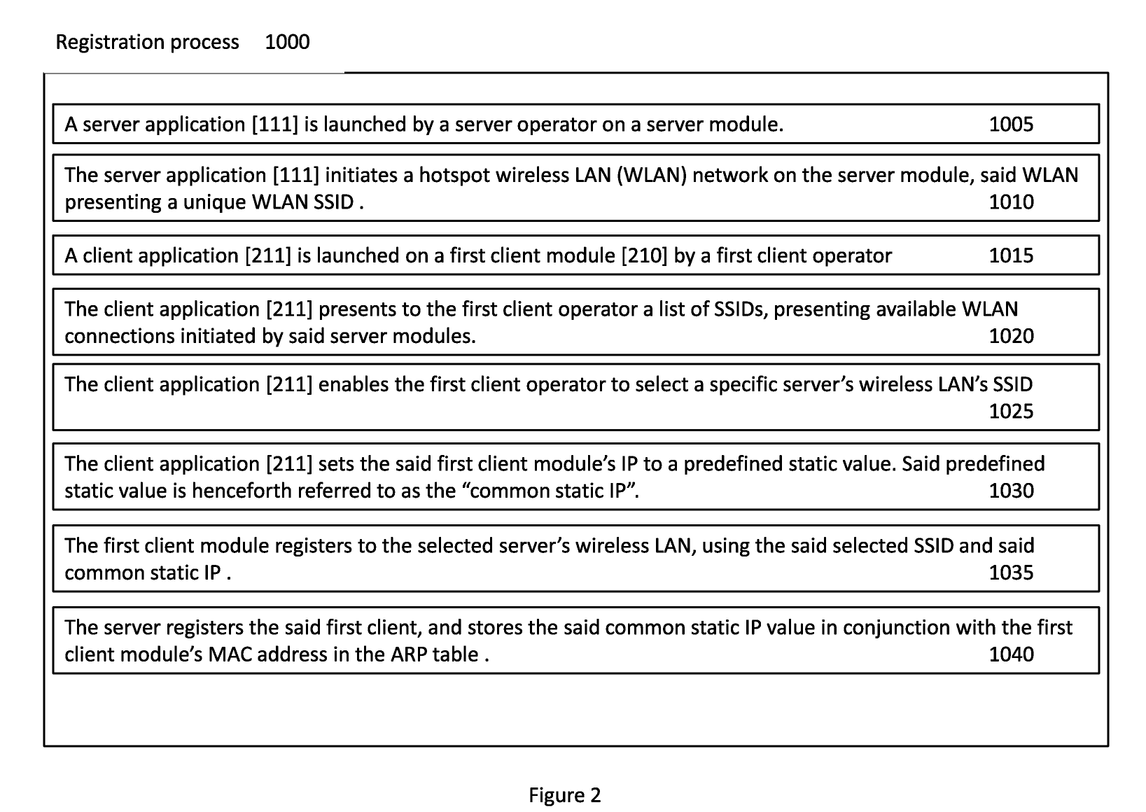

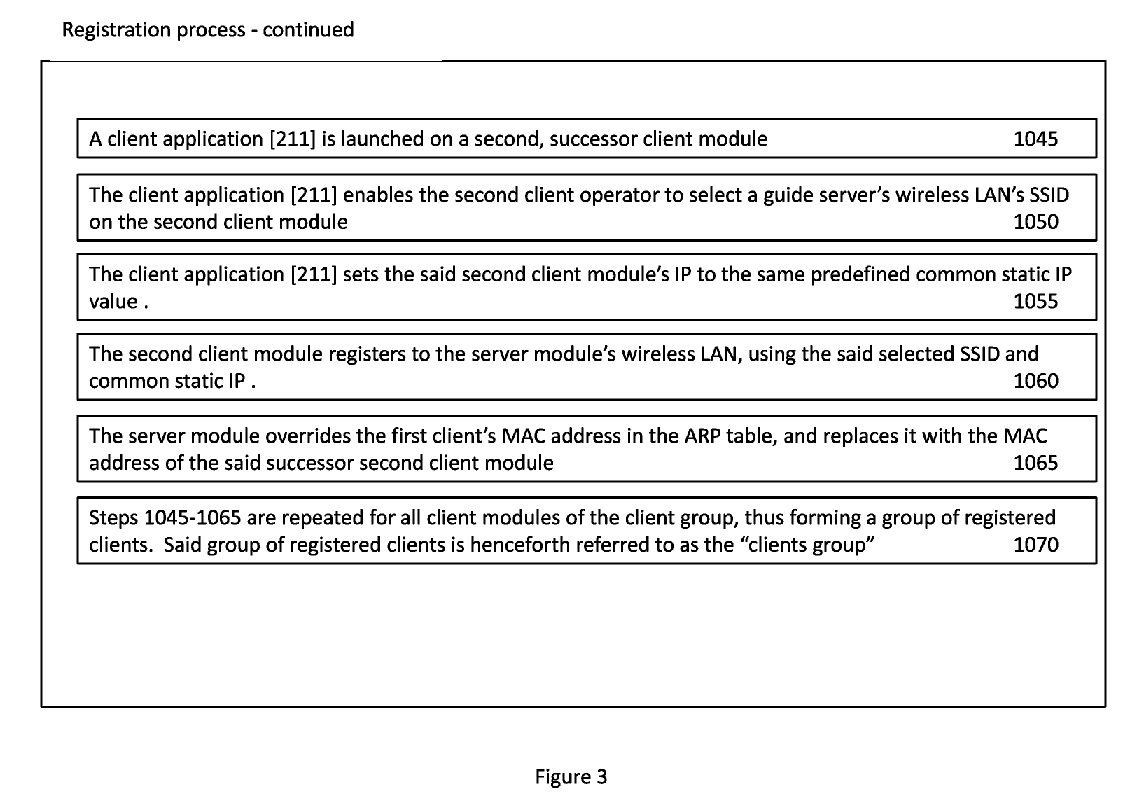

FIGS. 2 and 3 jointly display a flow diagram, depicting the process of client modules' registration to the WLAN initiated by the server module, according to some embodiments of the present invention.

A server application [111] is launched by a server operator on a server module. (step 1005).

The server application [111] initiates a hotspot wireless LAN (WLAN) network on the server module, said WLAN presenting a unique WLAN SSID (step 1010).

A client application [211] is launched on a first client module [210] by a first client operator (step 1015).

The client application [211] presents to the first client operator a list of SSIDs, presenting available WLAN connections initiated by said server modules (step 1020).

The client application [211] enables the first client operator to select a specific server's wireless LAN's SSID (step 1025).

The client application [211] sets the said first client module's IP to a predefined static value (step 1030). Said predefined static value is henceforth referred to as the “common static IP”.

The first client module registers to the selected server's wireless LAN, using the said selected SSID and said common static IP (step 1035).

The server registers the said first client, and stores the said common static IP value in conjunction with the first client module's MAC address in the ARP table (step 1040).

A client application [211] is launched on a second, successor client module (step 1045).

The client application [211] enables the second client operator to select a guide server's wireless LAN's SSID on the second client module (step 1050).

The client application [211] sets the said second client module's IP to the same predefined common static IP value (step 1055).

The second client module registers to the server module's wireless LAN, using the said selected SSID and common static IP (step 1060).

The server module overrides the first client's MAC address in the ARP table, and replaces it with the MAC address of the said successor second client module (step 1065).

Steps 1045-1065 are repeated for all client modules of the client group, thus forming a group of registered clients. Said group of registered clients is henceforth referred to as the “clients group” (step 1070). Ultimately, all clients of the same client group possess the same common static IP value, and the server module holds an ARP table wherein the said common static IP value is stored in conjunction with the MAC address of the last client module that has registered to the WLAN.

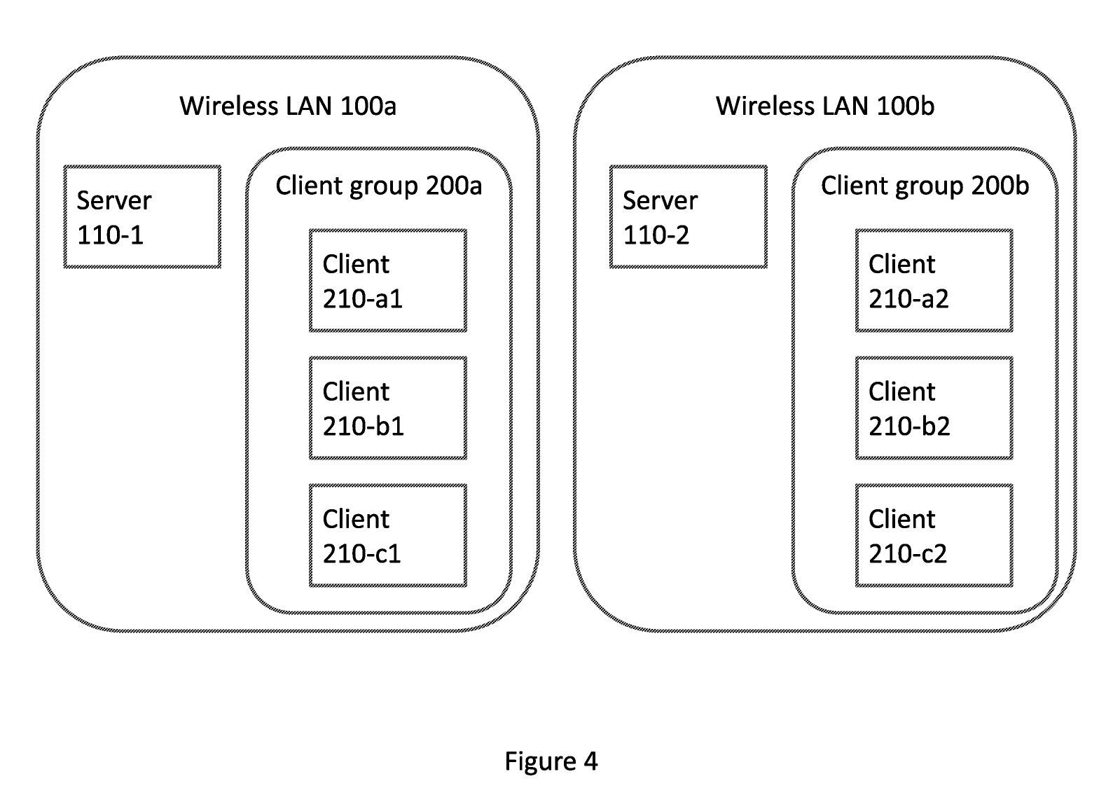

FIG. 4 displays a block diagram, depicting an environment comprising of two separate WLANs. Each said WLAN is initiated by a different server module, and comprises a separate, mutually exclusive group of client modules, according to some embodiments of the present invention.

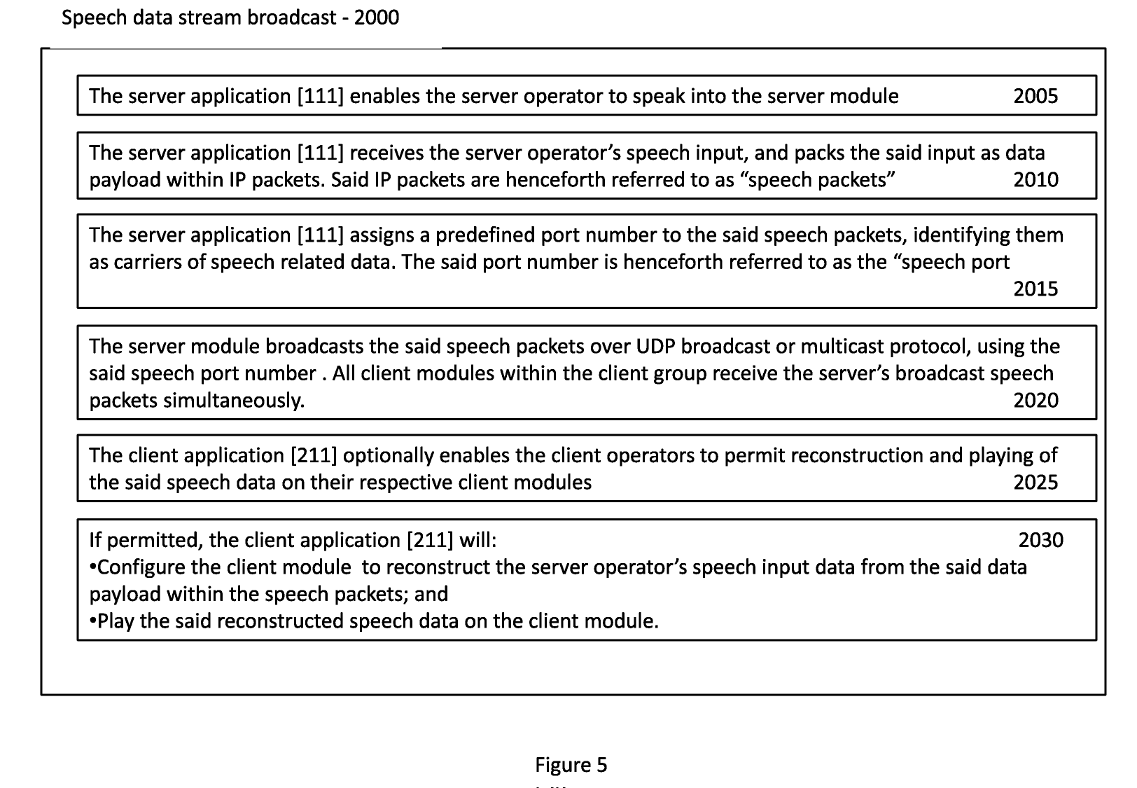

FIG. 5 displays a flow diagram depicting the process of speech data stream broadcast by the server module to the client modules of the client group, and playing said speech data thereof, according to some embodiments of the present invention.

The server application [111] enables the server operator to speak into the server module (step 2005).

The server application [111] receives the server operator's speech input, and packs the said input as data payload within IP packets. Said IP packets are henceforth referred to as “speech packets” (step 2010).

The server application [111] assigns a predefined port number to the said speech packets, identifying them as carriers of speech related data. The said port number is henceforth referred to as the “speech port” (step 2015).

The server module broadcasts the said speech packets over UDP broadcast or multicast protocol, using the said speech port number (step 2020). All client modules within the client group receive the server's broadcast speech packets simultaneously.

The client application [211] optionally enables the client operators to permit reconstruction and playing of the said speech data on their respective client modules (step 2025). If permitted, the client application [211] will (step 2030):
Configure the client module to reconstruct the server operator's speech input data from the said data payload within the speech packets; and
Play the said reconstructed speech data on the client module with no buffering and no delay.

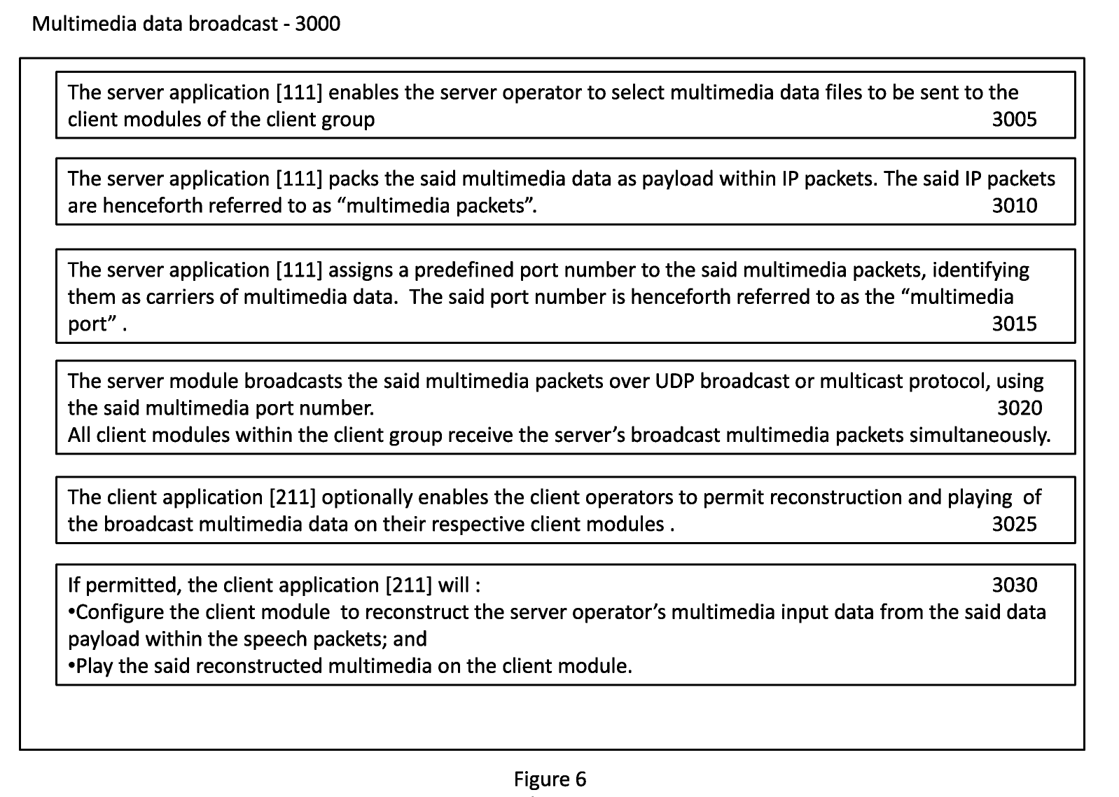

FIG. 6 displays a flow diagram depicting the process of multimedia data broadcast by the server module to the client modules of the client group, and display of said data thereof, according to some embodiments of the present invention.

The server application [111] enables the server operator to select multimedia data files to be sent to the client modules of the client group (step 3005).

The server application [111] packs the said multimedia data as payload within IP packets. The said IP packets are henceforth referred to as “multimedia packets” (step 3010).

The server application [111] assigns a predefined port number to the said multimedia packets, identifying them as carriers of multimedia data. The said port number is henceforth referred to as the “multimedia port” (step 3015).

The server module broadcasts the said multimedia packets over UDP broadcast or multicast protocol, using the said multimedia port number (step 3020). All client modules within the client group receive the server's broadcast multimedia packets simultaneously.

The client application [211] optionally enables the client operators to permit reconstruction and playing of the broadcast multimedia data on their respective client modules (step 3025). If permitted, the client application [211] will (step 3030):
Configure the client module to reconstruct the server operator's multimedia input data from the said data payload within the multimedia packets; and;
Play the said reconstructed multimedia on the client module.

According to some embodiments, the server operator has the ability to access the Internet, retrieve information and share the information with the clients.

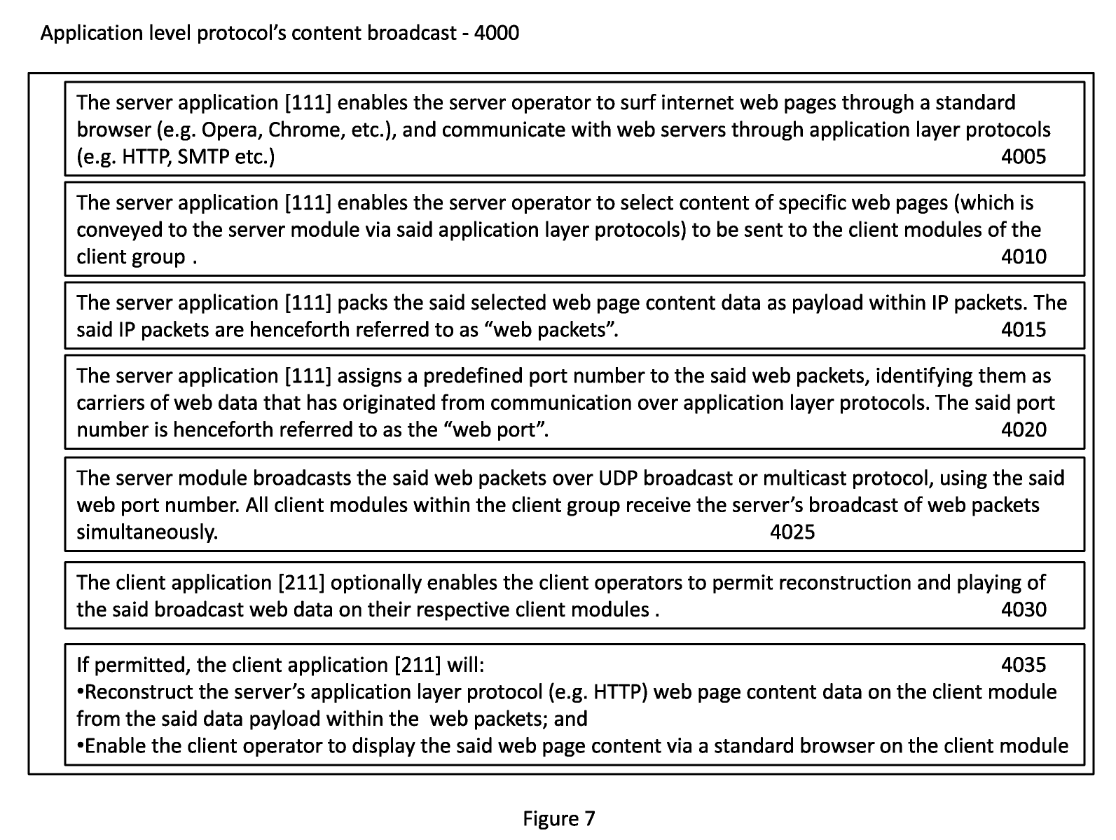

FIG. 7 displays a flow diagram depicting the process of application-layer data broadcast by the server module to the client modules of the client group, and display of said application layer data thereof, according to some embodiments of the present invention.

The server application [111] enables the server operator to surf internet web pages through a standard browser (e.g. Opera, Chrome, etc.), and communicate with web servers through application layer protocols (e.g. HTTP, SMTP etc.) (step 4005).

The server application [111] enables the server operator to select content of specific web pages (which is conveyed to the server module via said application layer protocols) to be sent to the client modules of the client group (step 4010).

The server application [111] packs the said selected web page content data as payload within IP packets. The said IP packets are henceforth referred to as “web packets” (step 4015).

The server application [111] assigns a predefined port number to the said web packets, identifying them as carriers of web data that has originated from communication over application layer protocols. The said port number is henceforth referred to as the “web port” (step 4020).

The server module broadcasts the said web packets over UDP broadcast or multicast protocol, using the said web port number (step 4025). All client modules within the client group receive the server's broadcast of web packets simultaneously.

The client application [211] optionally enables the client operators to permit reconstruction and playing of the said broadcast web data on their respective client modules (step 4030).

If permitted, the client application [211] will (step 4035):
reconstruct the server's application layer protocol (e.g. HTTP) web page content data on the client module from the said data payload within the web packets; and

Enable the client operator to display the said web page content via a standard browser on the client module.

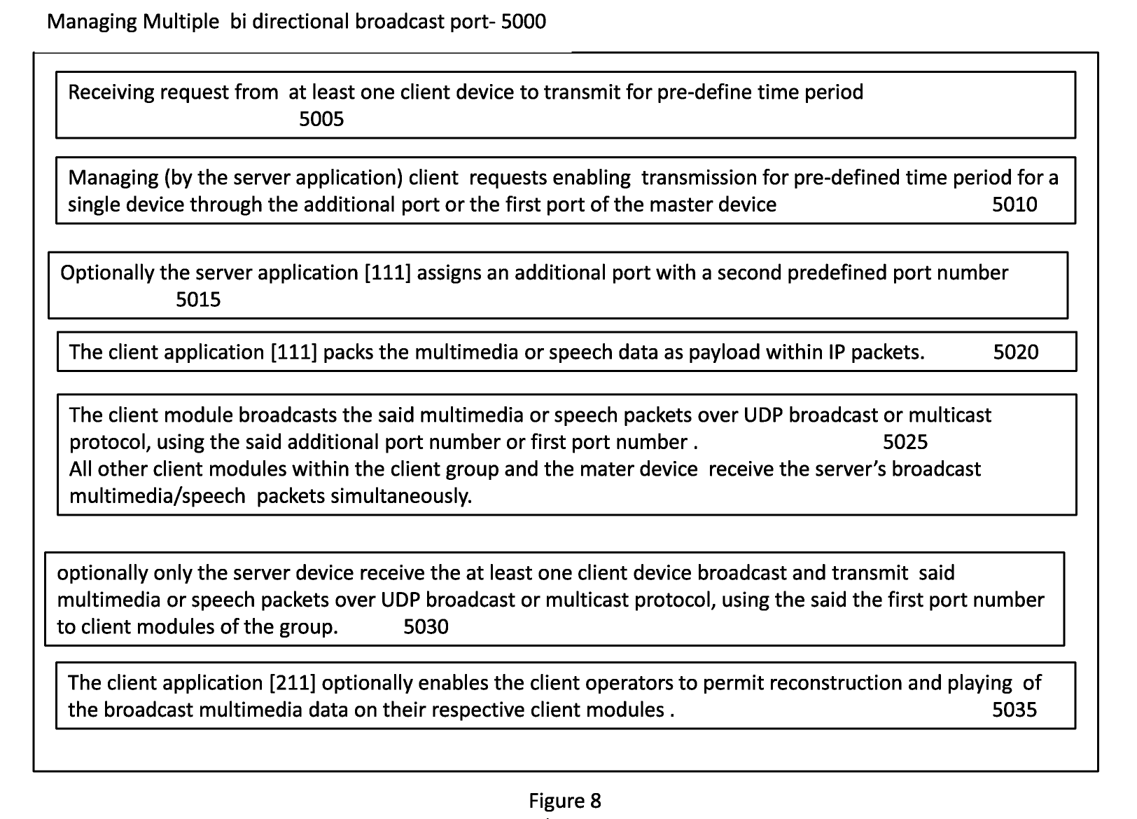

FIG. 8 displays a flow diagram depicting the process of managing Multiple bi directional broadcast port, according to some embodiments of the present invention. This process applies at least one of the following steps:
Receiving request from a client device to transmit for pre-define time period or prolong transmission time; (step 5005)
Managing client requests enabling transmission for pre-defined time period or prolonging transmission period, for a at least on device through the additional port or the first port of the master device; (step 5010)
Optionally the server application [111] assigns an additional port with a second predefined port number; (step 5015);
The client application [111] packs the multimedia or speech data as payload within IP packets. (step 5020);
The client module broadcasts the said multimedia or speech packets over UDP broadcast or multicast protocol, using the said additional port number or first port number. (step 5025);
All other client modules within the client group and the server module receive the server's broadcast of multimedia/speech packets simultaneously;(step 5030)
Optionally only the server device receive the at least one client device broadcast and transmits said multimedia or speech packets over UDP broadcast or multicast protocol, using the said the first port number to client modules of the group.(step 5035)
The client application [211] optionally enables the client operators to permit reconstruction and playing of the broadcast multimedia or speech data on their respective client modules; (step 5040)
If permitted, the client application [211] will Configure the client module to reconstruct the server operator's multimedia or speech input data from the said data payload within the speech packets; and play the said reconstructed multimedia or speech on the client module.

According to some embodiment of the present invention, a client device can make a request to the server application to get permission to transmit to the server and other client devices. This permission will be granted for a pre-set amount of time and the transmission will take place at this time window to permit, optionally others devices may transmit in the same time. If the client has need for more time it can make a new permission request.

sharing data between clients may be implemented in different protocols :
a. The client sends a request to the server and the server enables the client to share his data with the group at a time window determined by the server. In this case a client can send his data to the server any time period and the server share the data with the group at the same time period or different time period based on server priorities.
   Optionally the server determines when the client can share his data with the group.
b. The server determine at any time period based on ifs priorities to enable a the clients to share their data with the other group. In this case the first client to share is the first one that request to share. When the first client sharing action is over, the next one requesting client can share his data and so on. This sharing period will continue as long as the server allow this possibility. Optionally the server can determine the clients order and opens the transmission to every client upon his selection.
c. A client can burst to the network when the server is not busy.
   In this situation (like in B) the first client which request wins.

According to some embodiment of the present invention, the speech data is translated at each client device, to selected language.

According to some embodiments of the present invention, in case the server device is disconnected, one selected client module may take the place of the sever device, by initiating a WLAN hotspot network. This scenario requires to re-start the registration procedure as described above. The determination which client device will replace the server device can be based on different priority rules, such as/; the first to join the network or the client module with the strongest transmitting power or by random selection.

According to some embodiments of the present invention, the server device is not connected to an external network, such as the Internet or cellular network.

According to some embodiments of the present invention, the communication between the client device of one wireless network to another client of another wireless network distance of data transferring can be increased by using the WiFi or by using Bluetooth communication range enlargement can be achieved by adding commonly used WiFi Wireless Range Extender to the network made by companies like Netgear, TP-Link, Amped, D-Link etc.

Data that transmits by the server, receives and retransmits immediately by the Range Extenders to their clients.

The server may receive location data of each client device to know whether a client is in communication range or whether a client still connects to the network.

The system of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) limn including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perfoiin, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

1. A method for facilitating unilateral broadcast or multicast of data from at least one server module to a plurality of client modules, within at least one wireless LAN environment, each said server and said plurality of clients comprising a non-transitory computer readable storage device and one or more processors operatively coupled to the storage device on which are stored modules of instruction code executable by the one or more processors, whereupon execution of said instruction codes on the server module and said plurality of client modules carries out the steps of:
initiating a WLAN hotspot network by said server module;
setting the IP address of said client modules to a predefined common static IP value;
wherein said static IP value is common to all client modules within said wireless LAN environment;
registering said client module to said WLAN hotspot network using said common static IP value; and
broadcasting or multicasting data from said server module to said registered client modules of said WLAN hotspot network via UDP broadcast or multicast protocol.

2. The method of claim I wherein registering, comprise the following steps:
launching a client application on a first client module by a first client operator;
presenting to a first client operator a list of SSIDs, presenting available WLAN connections initiated by said server modules;
enabling the first client operator to select a specific server's wireless LAN's SSID;
setting by the client application said first client module's IP to a predefined static value, (“common static IP”).
registering by the client module to the selected server's wireless LAN, using the said selected SSID and said common static IP′; and
registering by the server, the said first client, and storing said common static IP value in conjunction with the first client module's MAC address in the ARP table.

3. The method of claim 2 wherein registering, further comprising the steps of :
launching a client application on a second, successor client module enables a second client operator to select a guide server's wireless LAN's SSID on the second client module;
client application sets the said second client module's IP to the same predefined common static IP value (step 1055).
registering to the server module's wireless LAN, using the said selected SSID and common static IP (step 1060).
Overriding by the server module the first client's MAC address in the ARP table, and replaces it with the MAC address of the said successor second client module.

4. The method of claim 1 wherein the broadcasting comprising the steps of:
enabling by server application, the server operator to speak into the server module;
receiving by the server application, the server operator's speech input, and packs the said input as data payload within IP packets. (“speech packets”);
assigning a predefined port (speech port) number to the said speech packets, identifying them as carriers of speech related data;
broadcasting the said speech packets over UDP broadcast or multicast protocol, using the said speech port number, wherein. all client modules within the client group receive the server's broadcast speech packets simultaneously

5. The method of claim 3 wherein the client device enables the client operators to permit reconstruction and playing of the said speech data on their respective client modules

6. The method of claim 3 wherein the playing of said reconstructed speech data on the client module is processed with no buffering and no delay.

7. The method of claim 1 wherein the broadcasting comprising the steps of:
enabling by server application, the server operator to select multimedia data files to be sent to the client modules of the client group;
receiving by the server application executes a dedicated server application, the server operator's select multimedia data, and packs the said select multimedia data as data payload within IP packets. (“multimedia packets”);
assigning a predefined port (“multimedia port”) number to the said multimedia packets, identifying them as carriers of speech related data;
broadcasting the said multimedia port packets over UDP broadcast or multicast protocol, using the said multimedia port number, wherein. all client modules within the client group receive the server's broadcast multimedia packets simultaneously.

8. The method of claim 1 further comprising managing routing, by:
receiving request from at least one client device to transmit for pre-define time period;
assigning by the server application an additional port with a second predefined port number;
managing client requests enabling transmission for pre-defined time period for at least one device through the additional port.

9. The method of claim 1 further comprising managing routing, by:
receiving request from client device to transmit for pre-define time period;
managing client requests enabling transmission for pre-defined time period for at least one device through the port of the master device; (step 5015)

10. The method of claim 9 wherein only the server device receive the at least one device broadcast and transmit, said multimedia or speech packets over UDP broadcast or multicast protocol, using the said the first port number to client modules of the group.

11. The method of claim 1 wherein, in case the server device is disconnected, one selected client module may take the place of the sever device, by initiating a WLAN hotspot network, wherein the registration procedure is applied the selected client module.

12. The method of claim 11 wherein the client device is selected based on programed priority rules.

13. The method of claim 1 wherein, the server device is not connected to an external network, such as the Internet or cellular network

14. A system for facilitating unilateral broadcast or multicast of data between communication devices within a wireless LAN environment, said system comprised of:
a server module applying a dedicated server application for initiating a WLAN hotspot network;
plurality of client modules having a dedicated client application;
wherein the sever module set the IP address of said client modules to a predefined common static IP value, wherein said static IP value is common to all client modules within said wireless LAN environment;
wherein each client module application registering to said WLAN hotspot network using said common static IP value; and
wherein the broadcasting or multicasting data from said server module to said registered client modules of said WLAN hotspot network via UDP broadcast or multicast protocol.

15. The system of claim 14 wherein registering, comprise the following steps:
launching a client application on a first client module by a first client operator;
presenting to a first client operator a list of SSIDs, presenting available WLAN connections initiated by said server modules;
enabling the first client operator to select a specific server's wireless LAN's SSID;
setting by the client application said first client module's IP to a predefined static value, (“common static IP”).
registering by the client module to the selected server's wireless LAN, using the said selected SSID and said common static IP′; and
registering by the server, the said first client, and storing said common static IP value in conjunction with the first client module's MAC address in the ARP table.

16. The system of claim 14 wherein registering, further comprising the steps of :
launching a client application on a second, successor client module enables a second client operator to select a guide server's wireless LAN's SSID on the second client module;
client application sets the said second client module's IP to the same predefined common static IP value (step 1055).
registering to the server module's wireless LAN, using the said selected SSID and common static IP (step 1060).
Overriding by the server module the first client's MAC address in the ARP table, and replaces it with the MAC address of the said successor second client module.

17. The system of claim 14 wherein the broadcasting comprising the steps of:
enabling by server application, the server operator to speak into the server module;
receiving by the server application, the server operator's speech input, and packs the said input as data payload within IP packets. (“speech packets”);
assigning a predefined port (speech port) number to the said speech packets, identifying them as carriers of speech related data;
broadcasting the said speech packets over UDP broadcast or multicast protocol, using the said speech port number, wherein. all client modules within the client group receive the server's broadcast speech packets simultaneously

18. The system of claim 17 wherein the client device enables the client operators to permit reconstruction and playing of the said speech data on their respective client modules

19. The system of claim 17 wherein the play of said reconstructed speech data on the client module is processed with no buffering and no delay.

20. The system of claim 14 wherein the broadcasting comprising the steps of:
enabling by server application, the server operator to select multimedia data files to be sent to the client modules of the client group;
receiving by the server application executes a dedicated server application, the server operator's select multimedia data, and packs the said select multimedia data as data payload within IP packets. (“multimedia packets”);
assigning a predefined port (“multimedia port”) number to the said multimedia packets, identifying them as carriers of speech related data;
broadcasting the said multimedia port packets over UDP broadcast or multicast protocol, using the said multimedia port number, wherein. all client modules within the client group receive the server's broadcast multimedia packets simultaneously.

21. The system of claim 14 further comprising managing routing, by:
receiving request from at least one client device to transmit for pre-define time period;
assigning by the server application an additional port with a second predefined port number;
managing client requests enabling transmission for pre-defined time period for at least one device through the additional port.

22. The system of claim 14 further comprising managing routing, by:
receiving request from client device to transmit for pre-define time period;
managing client requests enabling transmission for pre-defined time period for at least one device through the port of the master device; (step 5015)

23. The system of claim 22 wherein only the server device receive the at least one device broadcast and transmit, said multimedia or speech packets over UDP broadcast or multicast protocol, using the said the first port number to client modules of the group.

24. The systems of claim 14 wherein, in case the server device is disconnected, one selected client module may take the place of the sever device, by initiating a WLAN hotspot network, wherein the registration procedure is applied the selected client module.
